(19) United States
(12) Patent Application Publication
(10) Pub. No.: US 2017/0205962 A1
(43) Pub. Date: Jul. 20, 2017

(54) METHOD AND APPARATUS FOR RECOGNIZING GESTURE

(71) Applicant: Beijing Xiaomi Mobile Software Co., Ltd., Beijing (CN)

(72) Inventors: Guosheng LI, Beijing (CN); Wei SUN, Beijing (CN); Zhongsheng JIANG, Beijing (CN)

(73) Assignee: Beijing Xiaomi Mobile Software Co., Ltd.

(21) Appl. No.: 15/409,017

(22) Filed: Jan. 18, 2017

(30) Foreign Application Priority Data
Jan. 19, 2016 (CN) 201610035203.3

(51) Int. Cl. G06F 3/042; G06F 3/0488

(52) U.S. Cl. CPC G06F 3/0421; G06F 3/04883; G06F 2203/04108

(57) ABSTRACT

A method for recognizing a gesture includes: when light going into an ambient-light sensor is obstructed and no touch operation on the touch screen is detected, detecting whether the ambient-light sensor satisfies a preset change condition, the preset change condition including that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state; when the ambient-light sensor satisfies the preset change condition, determining a position of the ambient-light sensor; and recognizing an operation gesture of a user according to the position of the ambient-light sensor.

### CROSS-REFERENCE TO RELATED APPLICATIONS

The present application is based upon and claims priority to Chinese Patent Application No. 201610035203.3 filed Jan. 19, 2016, the entire contents of which are incorporated herein by reference.

### TECHNICAL FIELD

The present disclosure generally relates to the field of display technology, and more particularly, to a method and an apparatus for recognizing a gesture.

### BACKGROUND

As the touch screen technology advances, touch screens tend to have more and more functions, such as a function of recognizing a gesture.

In the related art, a terminal may determine a position where a user touches a touch screen of the terminal, and recognize a gesture made by the user based on the touch position. For example, the user has to touch the touch screen with a finger for the terminal to recognize the operation gesture of the user. That is, the operation gesture needs to be applied on the touch screen. However, when the user's finger(s) are dirty or it is inconvenient for the user to touch the touch screen, the user has to clean his or her finger(s) before the user can perform the touch operation, which is not efficient for operating the terminal. Further, if the user performs a touch operation on the touch screen with dirty finger(s), the touch screen may be contaminated. In order to solve this problem, the present disclosure provides methods in which the operation gesture of the user can be recognized without the user's finger(s) touching the touch screen.

### SUMMARY

According to a first aspect of embodiments of the present disclosure, there is provided a method for recognizing a gesture. The method is performed by a terminal containing a touch screen having ambient-light sensors and includes: when light going into an ambient-light sensor is obstructed and no touch operation on the touch screen is detected, detecting whether the ambient-light sensor satisfies a preset change condition, the preset change condition including that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state; when the ambient-light sensor satisfies the preset change condition, determining a position of the ambient-light sensor; and recognizing an operation gesture of a user according to the position of the ambient-light sensor.

According to a second aspect of embodiments of the present disclosure, there is provided an apparatus for recognizing a gesture. The apparatus contains a touch screen having ambient-light sensors and includes a processor and a memory for storing instructions executable by the processor. The processor is configured to perform: when light going into an ambient-light sensor is obstructed and no touch operation on the touch screen is detected, detecting whether the ambient-light sensor satisfies a preset change condition, the preset change condition including that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state; when the ambient-light sensor satisfies the preset change condition, determining a position of the ambient-light sensor; and recognizing an operation gesture of a user according to the position of the ambient-light sensor.

According to a third aspect of embodiments of the present disclosure, there is provided a non-transitory computer-readable storage medium storing instructions that, when executed by a processor in an apparatus containing a touch screen having ambient-light sensors, cause the apparatus to perform a method for recognizing a gesture, the method comprising: when light going into an ambient-light sensor is obstructed and no touch operation on the touch screen is detected, detecting whether the ambient-light sensor satisfies a preset change condition, the preset change condition including that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state; when the ambient-light sensor satisfies the preset change condition, determining a position of the ambient-light sensor; and recognizing an operation gesture of a user according to the position of the ambient-light sensor.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for recognizing a gesture according to an exemplary embodiment.

FIG. 2A is a flow chart illustrating a method for recognizing a gesture according to another exemplary embodiment.

FIG. 2B is a schematic diagram illustrating a process of determining an operation position of an operation gesture according to an exemplary embodiment.

FIG. 2C is a schematic diagram illustrating a process of determining an operation position of an operation gesture according to another exemplary embodiment.

FIG. 2D is a schematic diagram illustrating a process of recognizing an operation gesture according to an exemplary embodiment.

FIG. 2E is a schematic diagram illustrating a process of recognizing an operation gesture according to another exemplary embodiment.

FIG. 2F is a schematic diagram illustrating a process of recognizing an operation gesture according to another exemplary embodiment.

FIG. 2G is a flow chart illustrating a method for recognizing a speed of a gesture according to an exemplary embodiment.

FIG. 2H is a flow chart illustrating a method for recognizing an obstructing gesture according to an exemplary embodiment.

FIG. 3 is a block diagram illustrating an apparatus for recognizing a gesture according to an exemplary embodiment.

FIG. 4 is a block diagram illustrating an apparatus for recognizing a gesture according to an exemplary embodiment.

FIG. 5 is a block diagram illustrating an apparatus for recognizing a gesture according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

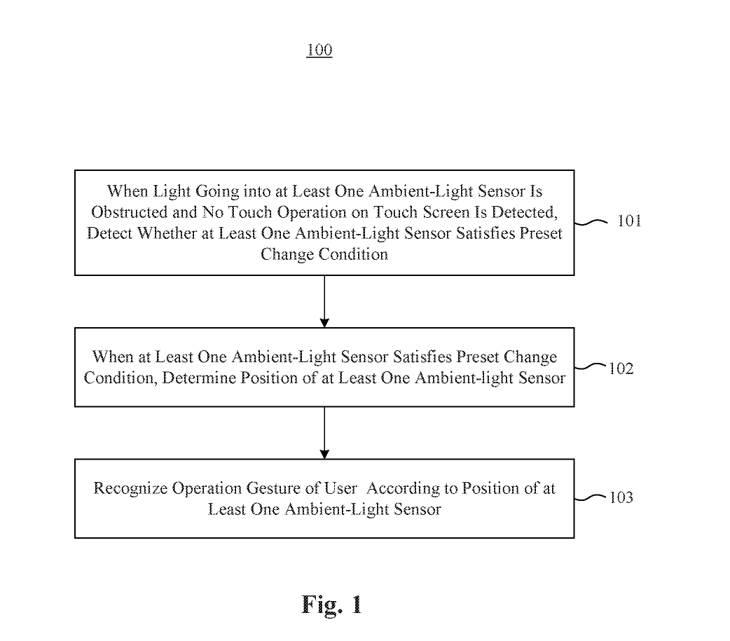

FIG. 1 is a flow chart illustrating a method 100 for recognizing a gesture according to an exemplary embodiment. The method 100 may be performed by a terminal containing a touch screen in which a plurality of ambient-light sensors are disposed. As shown in FIG. 1, the method 100 for recognizing a gesture includes the following steps.

In step 101, when light going into at least one ambient-light sensor is obstructed and no touch operation on the touch screen is detected, it is detected whether the at least one ambient-light sensor satisfies a preset change condition. The preset change condition includes that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state.

In step 102, when the at least one ambient-light sensor satisfies the preset change condition, the position of the at least one ambient-light sensor is determined.

In step 103, an operation gesture of a user is recognized according to the position of the at least one ambient-light sensor.

In the illustrated embodiment, when light going into at least one ambient-light sensor is obstructed and no touch operation on the touch screen is detected, it is detected that whether the light going into the at least one ambient-light sensor is changed from a non-obstructed state to an obstructed state and then changed from the obstructed state to the non-obstructed state. If the at least one ambient-light sensor detects the above change condition, the operation gesture of the user may be recognized according to the position of the at least one ambient-light sensor. Accordingly, the terminal can recognize the operation gesture made by the user without requiring the user to perform a touch operation on the touch screen. In this way, it can solve the problem that the terminal cannot recognize the operation gesture made by the user when it is not convenient for the user to perform a touch operation on the touch screen. Moreover, it can provide more ways for recognizing a user gesture and improve flexibility of recognizing a user gesture.

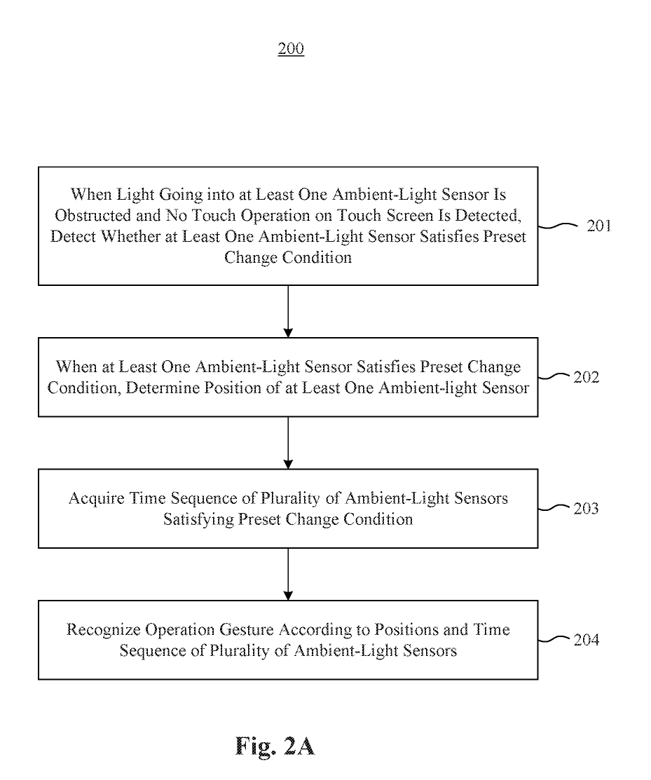

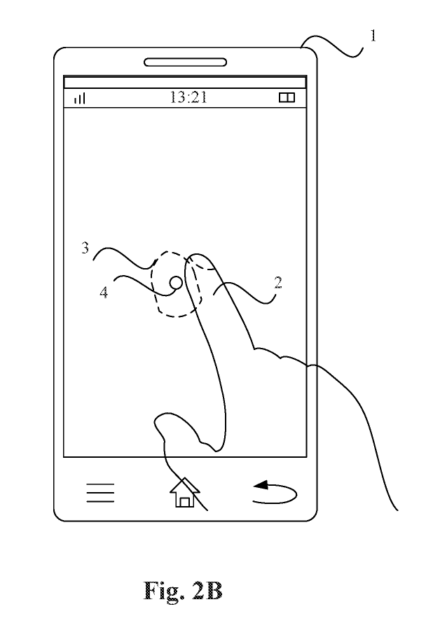

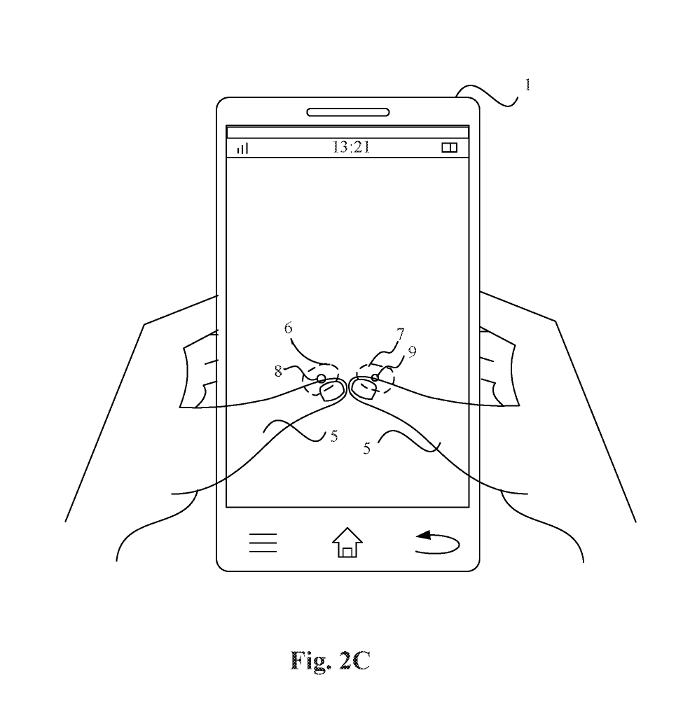

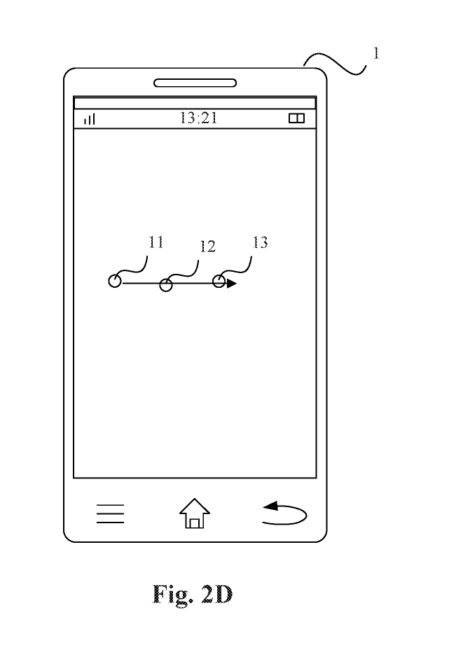

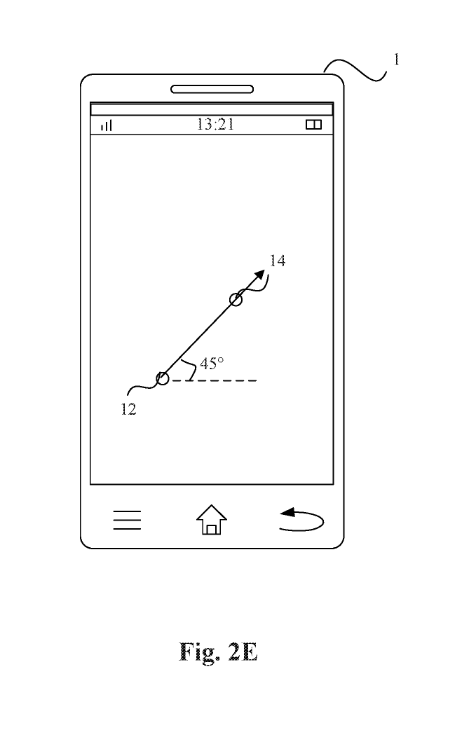

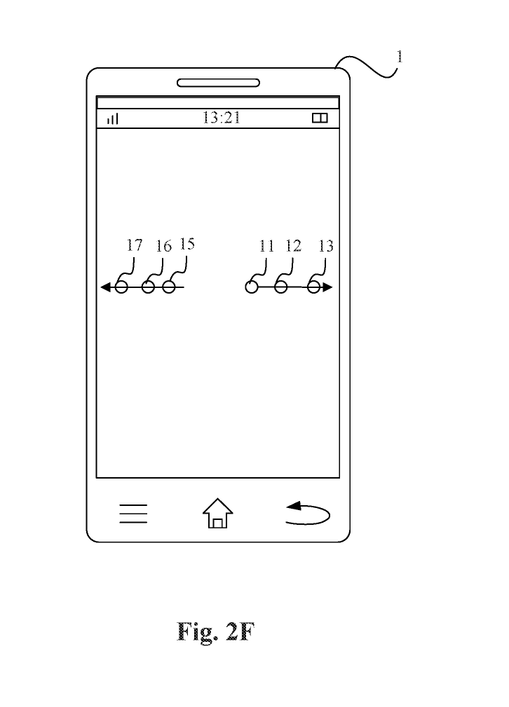

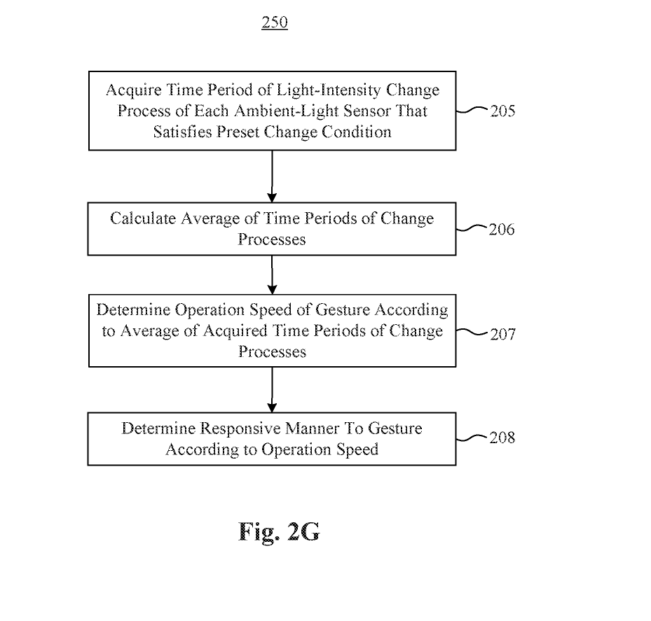

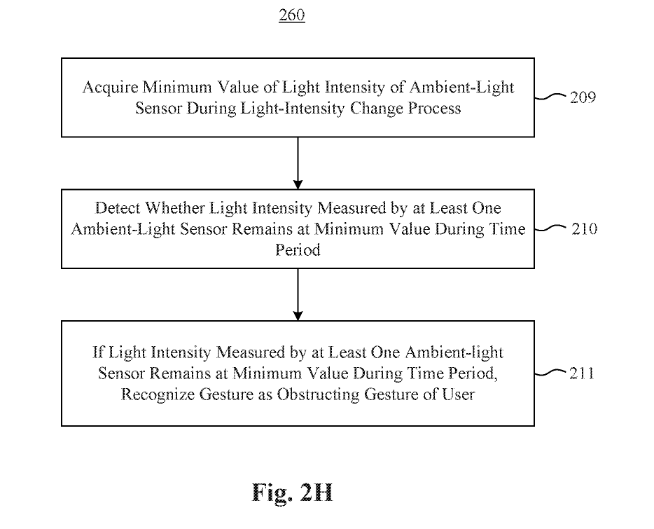

FIG. 2A is a flow chart illustrating a method 200 for recognizing a gesture according to another exemplary embodiment. The method 200 may be performed by a terminal containing a touch screen in which a plurality of ambient-light sensors are disposed. As shown in FIG. 2A, the method 200 for recognizing a gesture includes the following steps.

In step 201, when light going into at least one ambient-light sensor is obstructed and no touch operation on the touch screen is detected, it is detected whether the at least one ambient-light sensor satisfies a preset change condition, wherein the preset change condition is that the light going into the ambient-light sensor is changed from a non-obstructed state to an obstructed state and then changed from the obstructed state to the non-obstructed state.

The ambient-light sensors disposed in the touch screen may measure a light intensity of the light going into the ambient-light sensors. When an object obstructs the light going into the touch screen, the light intensity measured by the ambient-light sensors decreases. Accordingly, whether the light going into the ambient-light sensor is obstructed can be determined according to the measured light intensity. The obstructing event may be reported to the terminal.

Upon receiving a reported obstructing event from at least one ambient-light sensor, the terminal may detect whether there is a touch operation on the touch screen. If a touch operation is being applied on the touch screen, it can be determined that the obstructing event is caused by the touch operation on the touch screen. Otherwise, if no touch operation is applied on the touch screen, it can be determined that the obstructing event is caused by an operation gesture that does not touch the touch screen.

For example, an operation gesture is a sliding gesture. During the operation process of the sliding gesture, the light going into the ambient-light sensor is changed from a non-obstructed state to an obstructed state and then changed from the obstructed state to the non-obstructed state. Accordingly, whether the operation gesture made by the user is a sliding gesture can be determined by detecting whether the at least one ambient-light sensor satisfies the above preset change condition.

In some embodiments, the method for detecting whether the at least one ambient-light sensor satisfies the above preset change condition may include the following steps.

A light intensity measured by an ambient-light sensor is acquired. It is detected whether the light intensity decreases and then increases. If the light intensity decreases and then increases, it can be determined that the light going into the ambient-light sensor is changed from a non-obstructed state to an obstructed state and then changed from the obstructed state to the non-obstructed state, which satisfies the preset change condition.

When the light going into the ambient-light sensor is not obstructed, the light intensity measured by the ambient-light sensor is relatively large. When the light going into the ambient-light sensor is obstructed, the light intensity measured by the ambient-light sensor is relatively small. Therefore, the change of the light intensity can be measured by the ambient-light sensor to determine whether the light is obstructed from going into the ambient-light sensor. That is, when the light intensity changes from a larger value to a smaller value, it may be determined that the light going into the ambient-light sensor is changed from a non-obstructed state to an obstructed state; and when the light intensity changes from a smaller value to a larger value, it may be determined that the light going into the ambient-light sensor is changed from the obstructed state to the non-obstructed state.

In step 202, when at least one ambient-light sensor satisfies the preset change condition, the position of the at least one ambient-light sensor is determined.

When a user is making an operation gesture at a present time, since the user's finger(s) obstructs the light going into an ambient-light sensor, at least one shaded area will be formed on the touch screen. In the present embodiment, a central part of the shaded area may be taken as a position of the ambient-light sensor which satisfies the preset change condition at the present time. This is the operation position of the operation gesture at the present time.

For example, as shown in FIG. 2B, at a certain time, the user makes an operation gesture 2 which forms a shaded area 3 on a terminal 1. The terminal 1 acquires a position of at least one ambient-light sensor by calculating a central point 4 of the shaded area 3. That is, the central point 4 is where the at least one ambient-light sensor is located and taken as the operation position of the operation gesture at that time.

As another example, as shown in FIG. 2C, at another time, the user makes an operation gesture 5 which forms shaded areas 6 and 7 on the terminal 1. The terminal 1 acquires a position of a first ambient-light sensor by calculating a central point 8 of the shaded area 6. The terminal 1 acquires a position of a second ambient-light sensor by calculating a central point 9 of the shaded area 7. That is, the central points 8 and 9 are where the first and second ambient-light sensors are located and taken as the operation positions of the operation gesture at that time.

In some embodiments, a region corresponding to a plurality of ambient-light sensors, which are adjacent to each other and detect an identical intensity at the same time, may be determined as a shaded area. The present disclosure does not limit methods for determining a shaded area.

The terminal may determine an operation position of an operation gesture at each time according to the position of the at least one ambient-light sensor, and may recognize the operation gesture of the user according to the operation position at each time.

In step 203, a time sequence of a plurality of ambient-light sensors satisfying the preset change condition is acquired.

If an ambient-light sensor reports an obstructing event, i.e., it satisfies the preset change condition, to the terminal, upon receiving the report of the obstructing event, the terminal may record a receiving time of the obstructing event. Therefore, when the operation gesture of the user is generated by a series of successive actions, such as a sliding operation, the terminal may acquire times of the ambient-light sensors reporting their obstructing events and may determine a time sequence of light-obstructing events of the ambient-light sensors according to the acquired times.

In step 204, an operation gesture is recognized according to the positions of the ambient-light sensors and the time sequence of light-obstructing events.

According to the operation position(s) of the operation gesture at each time determined in step 202, an operation trajectory of the operation gesture without contacting the touch screen can be obtained. According to the time sequence of light-obstructing events determined in step 203, the operation direction of the operation gesture can be obtained. The terminal may recognize the operation gesture made by the user according to the operation trajectory and direction.

For example, as shown in FIG. 2D, in the terminal 1, an operation position 11 is determined at a first time, an operation position 12 is determined at a second time later than the first time, and an operation position 13 is determined at a third time later than the first and second times. The operation gesture of the user as shown in FIG. 2D can be recognized as a rightward sliding gesture according to the determined positions and the time sequence of the determined positions.

In some embodiments, a first angle threshold and a second angle threshold may be set for the terminal to determine an operation direction of the operation gesture. In one embodiment, for example, the second angle threshold is larger than the first angle threshold. The terminal may randomly select operation positions determined at different two times. If an angle between a connecting line of the two operation positions and a horizontal direction is smaller than the first angle threshold, the operation gesture may be recognized as a leftward or rightward sliding operation. If the angle between the connecting line of the two operation positions and the horizontal direction is larger than the first angle threshold and smaller than the second angle threshold, the operation gesture may be recognized as a sliding operation in a diagonal direction. If the angle between the connecting line of the two operation positions and the horizontal direction is larger than the second angle threshold, the operation gesture may be recognized as an upward or downward sliding operation.

For example, the first angle threshold is set at 30 degrees, and the second angle threshold is set at 60 degrees. As shown in FIG. 2E, in the terminal 1, an operation position 12 is determined at a first time and an operation position 14 is determined at a second time later than the first time. An angle between a connecting line of the two operation positions 12 and 14 and the horizontal direction is 45 degrees, which is larger than the first angle threshold and smaller than the second angle threshold. In this case, according to the determined positions 12 and 14, the time sequence of the determined positions 12 and 14, and the angle between the connecting line and the horizontal direction, the terminal may recognize the operation gesture of the user as an upper-right sliding gesture.

In some embodiments, the terminal may also calculate an average of angles formed between connecting lines of a plurality of pairs of operation positions at successive times and the horizontal direction, and compare the average angle with the first angle threshold and the second angle threshold. If the average angle is smaller than the first angle threshold, the operation gesture may be recognized as a leftward or rightward sliding operation. If the average angle is larger than the first angle threshold and smaller than the second angle threshold, the operation gesture may be recognized as a sliding operation in a diagonal direction. If the average angle is larger than the second angle threshold, the operation gesture may be recognized as an upward or downward sliding operation.

In some embodiments, the terminal determines at least two first operation positions at the same time. For each of the first operation positions, an operation position closest to the first operation position at successive times can be determined as one combined operation. The operation gesture of the user may be recognized according to the determined combined operation.

As shown in FIG. 2F, for example, in the terminal 1 operation positions 11 and 15 are determined at a first time; operation positions 12 and 16 are determined at a second time later than the first time; and operation positions 13 and 17 are determined at a third time later than the first and second times. In this case, the terminal may determine that the operation positions 11, 12, and 13 are one combined operation because they are close to each other, and that the operation positions 15, 16 and 17 are one combined operation because they are close to each other. The terminal 1 may recognize user's operation gesture according to the two combined operations.

In some embodiments, in order to provide more responsive manners to various operation gestures, the terminal may also recognize a speed of a gesture. FIG. 2G is a flow chart illustrating a method 250 for recognizing a speed of a gesture according to an exemplary embodiment. The method 250 for recognizing a speed of a gesture may be performed by a terminal containing a touch screen. Ambient-light sensors are disposed in the touch screen. As shown in FIG. 2G the method 250 for recognizing a speed of a gesture includes the following steps.

In step 205, a time period of a light-intensity change process of each ambient-light sensor that satisfies the preset change condition is acquired.

In one embodiment, for each ambient-light sensor that satisfies the preset change condition, the terminal records a first time when the light intensity at the ambient-light sensor starts to change and a second time when the change stops. The terminal may calculate a time period between the first time and the second time of the light intensity change process of the ambient-light sensor according to the recorded times. In another embodiment, the terminal may acquire a time period of a light intensity change process of the ambient-light sensor before the terminal detects that the ambient-light sensor satisfies the preset change condition. Upon detecting that the ambient-light sensor satisfies the preset change condition, the terminal may read out the time period of the change process previously acquired. In the present embodiment, how and when the terminal acquires the time period of the light intensity change process is not limited.

In step 206, an average of the time periods of the change processes is calculated.

The terminal may calculate an average of the acquired time periods of the change processes of ambient-light sensors that satisfy the preset change condition. In some embodiments, the terminal may select two or more time periods of change processes from the time periods of the change processes, and calculate an average of the selected time periods of the change processes.

In step 207, an operation speed of the gesture is determined according to the average of the acquired time periods of the change processes.

For example, a time threshold is set in advance for the terminal. The operation speed of the gesture may be determined by comparing the average time with the time threshold.

In the embodiment, one or more the time thresholds may be set.

For example, two time thresholds, a first time threshold and a second time threshold, are set in the terminal. The second time threshold is smaller than the first time threshold. If the average time is larger than the first time threshold, the terminal may determine that the gesture is a gesture at a slow speed. If the average time is smaller than the second time threshold, the terminal may determine that the gesture is a gesture at a fast speed. If the average time is larger than the second time threshold and smaller than the first time threshold, the terminal may determine that the gesture is a gesture at a moderate speed.

In step 208, the responsive manner to the gesture is determined according to the operation speed.

More responsive manners of the terminal to the user gestures may be achieved based on the recognition of the operation speeds of the operation gestures.

For example, a responsive manner to a speedy rightward sliding gesture may be a fast forward of a video, and a responsive manner to a slow rightward sliding gesture may be an instruction of jumping to the next video.

The present disclosure also provides a method for recognizing an obstructing gesture made by the user. FIG. 2H is a flow chart illustrating a method 260 for recognizing an obstructing gesture according to an exemplary embodiment. Referring to FIG. 2H, the method 260 includes the following steps.

In step 209, a minimum value of light intensity of an ambient-light sensor is acquired during the light-intensity change process.

If the terminal determines that there is at least one ambient-light sensor which satisfies the preset change condition, the terminal acquires a minimum value of the light intensity of each ambient-light sensor in the light-intensity change process. The minimum value is a light intensity measured by an ambient-light sensor when the light going into the ambient-light sensor is obstructed. Generally, the minimum value of the light intensity measured by each ambient-light sensor into which the light going is obstructed is the same.

In step 210, it is detected whether a light intensity measured by at least one ambient-light sensor remains at the minimum value during a time period.

After the terminal detects that a light intensity measured by at least one ambient-light sensor is a minimum value at a time, the terminal may detect whether a light intensity measured by the at least one ambient-light sensor remains at the minimum value during a time period.

In step 211, if the light intensity measured by the at least one ambient-light sensor remains at the minimum value during the time period, the gesture is recognized as an obstructing gesture of the user.

The terminal may recognize that the operation gesture of the user is an obstructing gesture when the light intensity measured by the at least one ambient-light sensor remains at the minimum value during the time period. More responsive manners of the terminal to the operation gestures may be achieved by recognizing the obstructing gesture of the user. For example, when the terminal recognizes that the user makes an obstructing gesture, a corresponding responsive manner may be a pause of playing a video or a music. In some embodiments, a corresponding responsive manner may be a selection of an application program.

In some embodiments, a first predetermined time period may be set in the terminal. When one or more light intensities measured by one or more ambient-light sensors remain at a minimum value for a time period longer than or equal to the first predetermined time period, the terminal may recognize the operation of the user as a first type of obstructing gesture. Further, a second predetermined time period may be set in the terminal. When one or more light intensities measured by one or more ambient-light sensors remain at a minimum value for a time period shorter than or equal to the second predetermined time, it may recognize the operation of the user as a second type of obstructing gesture. Different responsive manners may be set for the terminal corresponding to different types of obstructing gestures.

Accordingly, in the methods for recognizing a gesture provided by the present disclosure, when light going into at least one ambient-light sensor is obstructed and no touch operation applied on the touch screen is detected, and when it is detected that the light going into each of the ambient-light sensors is changed from a non-obstructed state to an obstructed state and then changed from the obstructed state to the non-obstructed state, the operation gesture of the user may be recognized according to the position of the at least one ambient-light sensor. The terminal can recognize the operation gesture made by the user without requiring the user to perform a touch operation on the touch screen. In this way, it can solve the problem that the terminal cannot recognize an operation gesture made by the user when it is not convenient for the user to perform a touch operation on the touch screen. Moreover, the present methods provide more ways for recognizing a gesture and improve the flexibility of recognizing a gesture.

In addition, by recognizing a speed of an operation gesture or an obstructing gesture, the types of operation gestures can be expanded. It can solve the problem of insufficiency of manners for responding to operation gestures due to insufficient types of user gestures without contacting the touch screen. Thus, the present methods provide more responsive manners to the operation gestures on the touch screen.

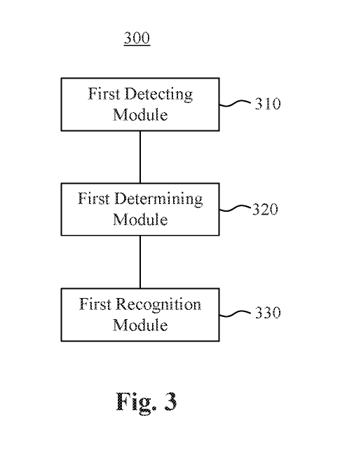

FIG. 3 is a block diagram illustrating an apparatus 300 for recognizing a gesture according to an exemplary embodiment. The apparatus 300 is applied into a terminal containing a touch screen in which ambient-light sensors are disposed. As shown in FIG. 3, the apparatus 300 for recognizing a gesture includes: a first detecting module 310, a first determining module 320, and a first recognition module 330.

The first detecting module 310 is configured to, when light going into at least one ambient-light sensor is obstructed and no touch operation on the touch screen is detected, detect whether the at least one ambient-light sensor satisfies a preset change condition. The preset change condition includes that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state.

The first determining module 320 is configured to, when the first detecting module 310 detects that the at least one ambient-light sensor satisfies the preset change condition, determine a position of the at least one ambient-light sensor.

The first recognition module 330 is configured to recognize an operation gesture of a user according to the position of the at least one ambient-light sensor, which is determined by the first determining module 320.

In the illustrated embodiment, when light going into at least one ambient-light sensor is obstructed and no touch operation on the touch screen is detected, it is detected that whether the light going into the at least one ambient-light sensor is changed from a non-obstructed state to an obstructed state and then changed from the obstructed state to the non-obstructed state. If the at least one ambient-light sensor detects the above change condition, the operation gesture of the user may be recognized according to the position of the at least one ambient-light sensor. Accordingly, the terminal can recognize the operation gesture made by the user without requiring the user to perform a touch operation on the touch screen. In this way, it can solve the problem that the terminal cannot recognize the operation gesture made by the user when it is not convenient for the user to perform a touch operation on the touch screen. Moreover, it can provide more ways for recognizing a user gesture and improve the flexibility of recognizing a user gesture.

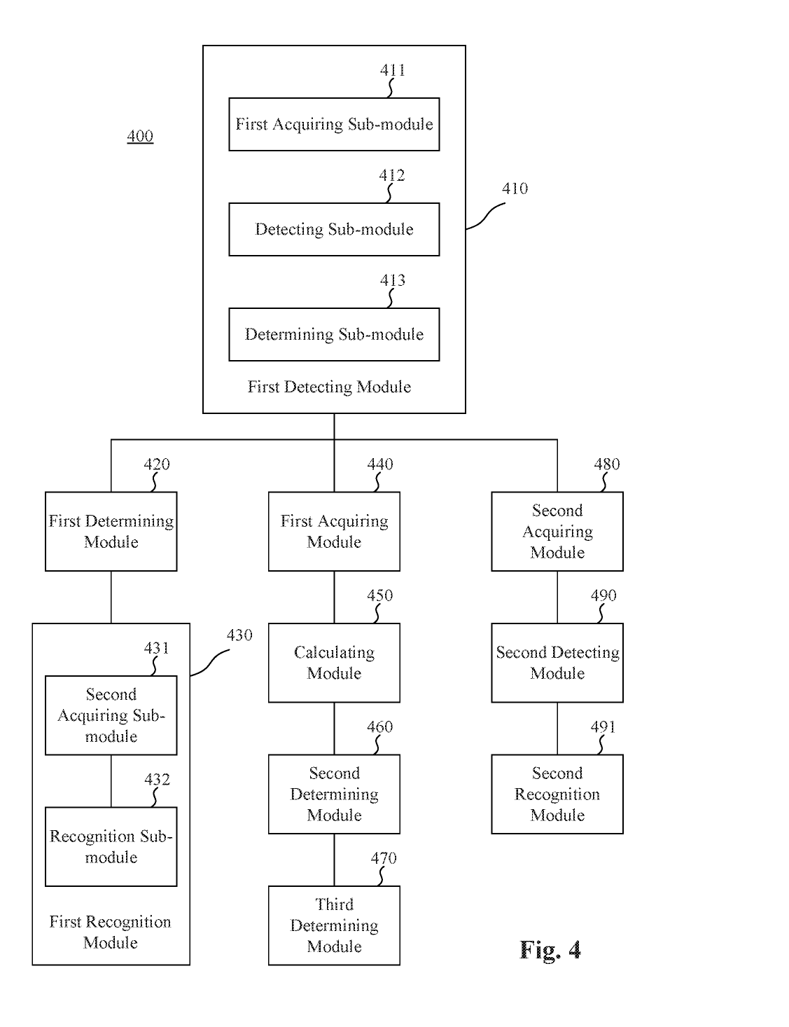

FIG. 4 is a block diagram illustrating an apparatus 400 for recognizing a gesture according to an exemplary embodiment. The apparatus 400 is applied in a terminal containing a touch screen in which ambient-light sensors are disposed. As shown in FIG. 4, the apparatus 400 for recognizing a gesture includes: a first detecting module 410, a first determining module 420, and a first recognition module 430.

The first detecting module 410 is configured to, when light going into at least one ambient-light sensor is obstructed and no touch operation on the touch screen is detected, detect whether the at least one ambient-light sensor satisfies a preset change condition, wherein the preset change condition is that the light going into the ambient-light sensor is changed from a non-obstructed state to an obstructed state and then changed from the obstructed state to the non-obstructed state.

The first determining module 420 is configured to, when the first detecting module 410 detects that at least one ambient-light sensor satisfies the preset change condition, determine a position of the at least one ambient-light sensor.

The first recognition module 430 is configured to recognize an operation gesture of a user according to the position of the at least one ambient-light sensor, which is determined by the first determining module 420.

In some embodiments, the first detecting module 410 includes: a first acquiring sub-module 411, a detecting sub-module 412, and a determining sub-module 413.

The first acquiring sub-module 411 is configured to acquire a light intensity measured by each of the ambient-light sensors.

The detecting sub-module 412 is configured to detect whether the light intensity acquired by the first acquiring sub-module 411 decreases and then increases.

The determining sub-module 413 is configured to, if the detecting sub-module 412 detects that the light intensity decreases and then increases, determine that the light going into the ambient-light sensor is changed from a non-obstructed state to an obstructed state and then changed from the obstructed state to the non-obstructed state, which satisfies the preset change condition.

In some embodiments, the first recognition module 430 includes: a second acquiring sub-module 431 and a recognition sub-module 432.

The second acquiring sub-module 431 is configured to acquire a time sequence of a plurality of ambient-light sensors satisfying the preset change condition.

The recognition sub-module 432 is configured to recognize an operation gesture according to the positions of the ambient-light sensors and the time sequence acquired by the second acquiring sub-module 431.

In some embodiments, the apparatus 400 further includes: a first acquiring module 440, a calculating module 450, a second determining module 460, and a third determining module 470.

The first acquiring module 440 is configured to acquire a time period of a light-intensity change process of each ambient-light sensor.

The calculating module 450 is configured to calculate an average of the time periods of the change processes acquired by the first acquiring module 440.

The second determining module 460 is configured to determine an operation speed of the gesture according to the average calculated by the calculating module 450.

The third determining module 470 is configured to determine a responsive manner to the gesture according to the operation speed determined by the second determining module 460.

In some embodiments, the apparatus 400 further includes: a second acquiring module 480, a second detecting module 490, and a second recognition module 491.

The second acquiring module 480 is configured to acquire a minimum value of light intensity of an ambient-light sensor during the light-intensity change process.

The second detecting module 490 is configured to detect whether a light intensity measured by at least one ambient-light sensor remains at the minimum value during a time period.

The second recognition module 491 is configured to, if the second detecting module 490 detects that the light intensity measured by the at least one ambient-light sensor remains at the minimum value during the time period, recognize the gesture as an obstructing gesture of the user.

Accordingly, in the apparatus for recognizing a gesture provided by the present disclosure, when light going into at least one ambient-light sensor is obstructed and no touch operation applied on the touch screen is detected, and when it is detected that the light going into each of the ambient-light sensors is changed from a non-obstructed state to an obstructed state and then changed from an obstructed state to a non-obstructed state, the operation gesture of the user may be recognized according to the position of the at least one ambient-light sensor. The terminal can recognize the operation gesture made by the user without requiring the user to perform a touch operation on the touch screen. In this way, it can solve the problem that the terminal cannot recognize an operation gesture made by the user when it is not convenient for the user to perform a touch operation on the touch screen. Moreover, the present methods provide more ways for recognizing a gesture and improve the flexibility of recognizing a gesture.

In addition, by recognizing a speed of an operation gesture and/or an obstructing gesture, the types of operation gestures can be expanded. It can solve the problem of insufficiency of manners for responding to operation gestures due to insufficient types of user gestures without contacting the touch screen. Thus, the present methods provide more the responsive manners to the operation gestures on the touch screen.

With respect to the apparatuses in the above embodiments, the specific manners for performing operations for individual modules or sub-modules therein have been described in detail in the embodiments regarding the methods of the present disclosure, which will not be repeated.

An exemplary embodiment of the present disclosure provides an apparatus for recognizing a gesture, which can implement the method for recognizing a gesture provided by the present disclosure. The apparatus for recognizing a gesture is applied in a terminal containing a touch screen with ambient-light sensors disposed therein. The apparatus includes a processor and a memory for storing instructions executable by the processor. The processor is configured to perform all or part of the methods described above.

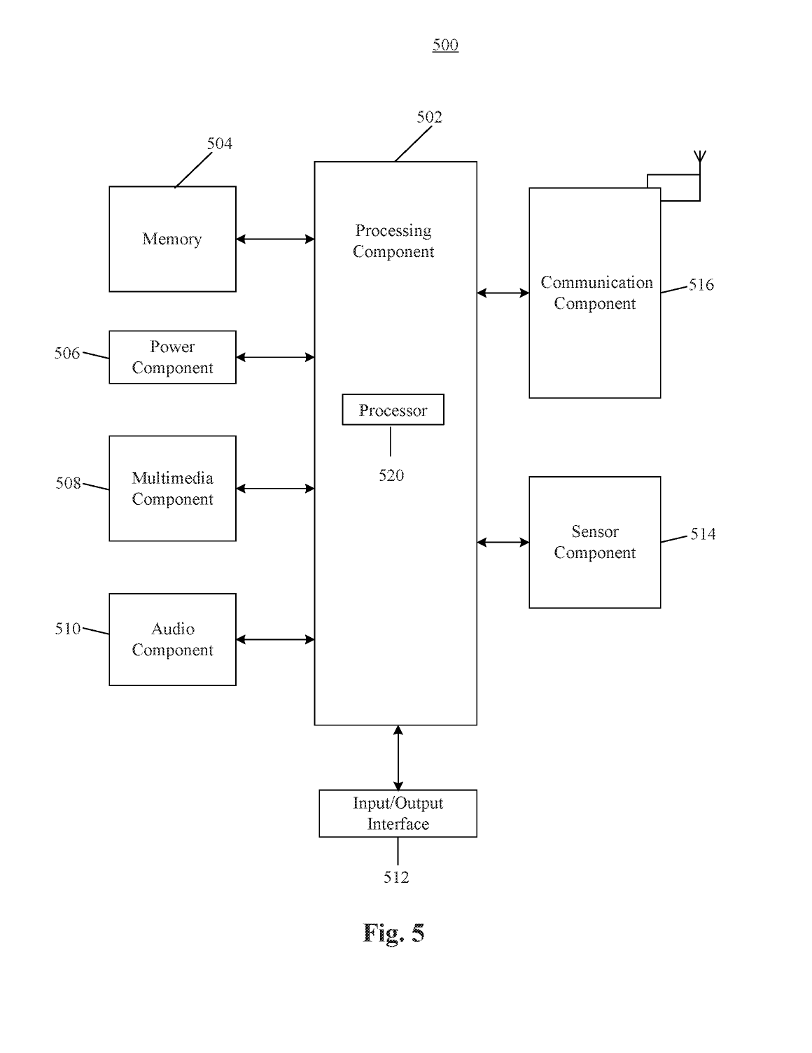

FIG. 5 is a block diagram illustrating an apparatus 500 for recognizing a gesture according to an exemplary embodiment. For example, the apparatus 500 may be a mobile phone, a computer, a digital broadcast terminal, a messaging device, a gaming console, a tablet, a medical device, exercise equipment, a personal digital assistant, and the like.

Referring to FIG. 5, the apparatus 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the apparatus 500, such as the operations associated with display, telephone calls, data communications, camera operations, and recording operations. The processing component 502 can include one or more processors 520 to execute instructions to perform all or part of the steps in the above described methods. Moreover, the processing component 502 can include one or more modules which facilitate the interaction between the processing component 502 and other components. For instance, the processing component 502 can include a multimedia module to facilitate the interaction between the multimedia component 508 and the processing component 502.

The memory 504 is configured to store various types of data to support the operation of the apparatus 500. Examples of such data include instructions for any applications or methods operated on the apparatus 500, contact data, phonebook data, messages, pictures, video, etc. The memory 504 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the apparatus 500. The power component 506 can include a power management system, one or more power sources, and any other components associated with the generation, management, and distribution of power in the apparatus 500.

The multimedia component 508 includes a screen providing an output interface between the apparatus 500 and the user. In some embodiments, the screen can include a liquid crystal display and a touch panel. If the screen includes the touch panel, the screen can be implemented as a touch screen to receive input signals from the user. The touch panel includes one or more touch sensors to sense touches, swipes, and gestures on the touch panel. The touch sensors can not only sense a boundary of a touch or swipe action, but also sense a period of time and a pressure associated with the touch or swipe action. In some embodiments, the multimedia component 508 includes a front camera and/or a rear camera. The front camera and the rear camera can receive an external multimedia datum while the apparatus 500 is in an operation mode, such as a photographing mode or a video mode. Each of the front camera and the rear camera can be a fixed optical lens system or have focus and optical zoom capability.

The audio component 510 is configured to output and/or input audio signals. For example, the audio component 510 includes a microphone configured to receive an external audio signal when the apparatus 500 is in an operation mode, such as a call mode, a recording mode, and a voice recognition mode. The received audio signal can be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons can include, but are not limited to, a home button, a volume button, a starting button, and a locking button.

The sensor component 514 includes one or more sensors to provide status assessments of various aspects of the apparatus 500. For instance, the sensor component 514 can detect an open/closed status of the apparatus 500, relative positioning of components, e.g., the display and the keypad, of the apparatus 500, a change in position of the apparatus 500 or a component of the apparatus 500, a presence or absence of user contact with the apparatus 500, an orientation or an acceleration/deceleration of the apparatus 500, and a change in temperature of the apparatus 500. The sensor component 514 can include a proximity sensor configured to detect the presence of nearby objects without any physical contact. The sensor component 514 can also include a ambient-light sensor, configured to detect the light intensity of the ambient light of the apparatus 500. In some embodiments, the sensor component 514 can also include an accelerometer sensor, a gyroscope sensor, a magnetic sensor, a pressure sensor, or a temperature sensor.

The communication component 516 is configured to facilitate communication, wired or wirelessly, between the apparatus 500 and other devices. The apparatus 500 can access a wireless network based on a communication standard, such as WiFi, 2G, 3G, or 4G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 500 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504, executable by the processor 520 in the apparatus 500, for performing the above-described methods. For example, the non-transitory computer-readable storage medium can be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for recognizing a gesture, the method being performed by a terminal containing a touch screen having ambient-light sensors, the method comprising:
when light going into an ambient-light sensor is obstructed and no touch operation on the touch screen is detected, detecting whether the ambient-light sensor satisfies a preset change condition, the preset change condition including that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state;
when the ambient-light sensor satisfies the preset change condition, determining a position of the ambient-light sensor; and
recognizing an operation gesture of a user according to the position of the ambient-light sensor.

2. The method of claim 1, wherein the detecting whether the ambient-light sensor satisfies the preset change condition comprises:
acquiring a light intensity measured by the ambient-light sensor;
detecting whether the light intensity decreases and then increases; and
if the light intensity decreases and then increases, determining that the light going into the ambient-light sensor is changed from the non-obstructed state to the obstructed state and then changed from the obstructed state to the non-obstructed state.

3. The method of claim 1, wherein the recognizing an operation gesture of a user according to the position of the ambient-light sensor comprises:
acquiring a time sequence of a plurality of ambient-light sensors satisfying the preset change condition;
determining positions of the plurality of ambient-light sensors; and
recognizing an operation gesture according to positions and the time sequence of the plurality of ambient-light sensors.

4. The method of claim 1, further comprising:
determining a plurality of ambient-light sensors satisfying the preset change condition;
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

5. The method of claim 2, further comprising:
determining a plurality of ambient-light sensors satisfying the preset change condition;
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

6. The method of claim 3, further comprising:
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

7. The method of claim 1, further comprising:
acquiring a minimum value of a light intensity measured by the ambient-light sensor;
detecting whether a light intensity measured by the ambient-light sensor remains at the minimum value during a time period; and
if the light intensity measured by the ambient-light sensor remains at the minimum value during the time period, recognizing the gesture as an obstructing gesture of the user.

8. An apparatus for recognizing a gesture, the apparatus containing a touch screen having ambient-light sensors, the apparatus comprising:
a processor; and
a memory for storing instructions executable by the processor,
wherein the processor is configured to perform:
when light going into an ambient-light sensor is obstructed and no touch operation on the touch screen is detected, detecting whether the ambient-light sensor satisfies a preset change condition, the preset change condition including that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state;
when the ambient-light sensor satisfies the preset change condition, determining a position of the ambient-light sensor; and
recognizing an operation gesture of a user according to the position of the ambient-light sensor.

9. The apparatus of claim 8, wherein the processor is further configured to perform:
acquiring a light intensity measured by the ambient-light sensor;
detecting whether the light intensity decreases and then increases; and
if the light intensity decreases and then increases, determining that the light going into the ambient-light sensor is changed from the non-obstructed state to the obstructed state and then changed from the obstructed state to the non-obstructed state.

10. The apparatus of claim 8, wherein the processor is further configured to perform:
acquiring a time sequence of a plurality of ambient-light sensors satisfying the preset change condition;
determining positions of the plurality of ambient-light sensors; and
recognizing an operation gesture according to positions and the time sequence of the plurality of ambient-light sensors.

11. The apparatus of claim 8, wherein the processor is further configured to perform:
determining a plurality of ambient-light sensors satisfying the preset change condition;
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

12. The apparatus of claim 9, wherein the processor is further configured to perform:
determining a plurality of ambient-light sensors satisfying the preset change condition;
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

13. The apparatus of claim 10, wherein the processor is further configured to perform:
determining a plurality of ambient-light sensors satisfying the preset change condition;
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

14. The apparatus of claim 8, wherein the processor is further configured to perform:
acquiring a minimum value of a light intensity measured by the ambient-light sensor;
detecting whether a light intensity measured by the ambient-light sensor remains at the minimum value during a time period; and
if the light intensity measured by the ambient-light sensor remains at the minimum value during the time period, recognizing the gesture as an obstructing gesture of the user.

15. A non-transitory computer-readable storage medium storing instructions that, when executed by a processor in an apparatus containing a touch screen having ambient-light sensors, cause the apparatus to perform a method for recognizing a gesture, the method comprising:
when light going into an ambient-light sensor is obstructed and no touch operation on the touch screen is detected, detecting whether the ambient-light sensor satisfies a preset change condition, the preset change condition including that the light going into the ambient-light sensor is changed from a non-obstructed state, in which the light is not obstructed from going into the ambient-light sensor, to an obstructed state, in which the light is obstructed from going into the ambient-light sensor, and then changed from the obstructed state to the non-obstructed state;
when the ambient-light sensor satisfies the preset change condition, determining a position of the ambient-light sensor; and
recognizing an operation gesture of a user according to the position of the ambient-light sensor.

16. The non-transitory computer-readable storage medium of claim 15, wherein the method further comprises:
acquiring a light intensity measured by the ambient-light sensor;
detecting whether the light intensity decreases and then increases; and
if the light intensity decreases and then increases, determining that the light going into the ambient-light sensor is changed from the non-obstructed state to the obstructed state and then changed from the obstructed state to the non-obstructed state.

17. The non-transitory computer-readable storage medium of claim 15, wherein the method further comprises:
acquiring a time sequence of a plurality of ambient-light sensors satisfying the preset change condition;
determining positions of the plurality of ambient-light sensors; and
recognizing an operation gesture according to positions and the time sequence of the plurality of ambient-light sensors.

18. The non-transitory computer-readable storage medium of claim 15, wherein the method further comprises:
determining a plurality of ambient-light sensors satisfying the preset change condition;
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

19. The non-transitory computer-readable storage medium of claim 16, wherein the method further comprises:
determining a plurality of ambient-light sensors satisfying the preset change condition;
acquiring, from the plurality of ambient-light sensors, time periods of change processes of the preset change condition;
calculating an average of the time periods of the change processes;
determining an operation speed of the gesture according to the average; and
determining a responsive manner to the gesture according to the operation speed.

20. The non-transitory computer-readable storage medium of claim 15, wherein the method further comprises:
acquiring a minimum value of a light intensity measured by the ambient-light sensor;
detecting whether a light intensity measured by the ambient-light sensor remains at the minimum value during a time period; and
if the light intensity measured by the ambient-light sensor remains at the minimum value during the time period, recognizing the gesture as an obstructing gesture of the user.
